(19) United States
(12) Patent Application Publication
(10) Pub. No.: US 2007/0207826 A1
(43) Pub. Date: Sep. 6, 2007

(54) Intelligent mobile switching center (MSC) feature control

(75) Inventor: Man Sang Lui, Richmond (CA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Incorporated, Alameda, CA (US)

(21) Appl. No.: 11/284,608

(22) Filed: Nov. 21, 2005

(51) Int. Cl. H04B 7/00

(52) U.S. Cl. 455/518; 455/418

(57) ABSTRACT

A home location register provides a mobile switching center with information grouping mobile devices in particular groups, such groups identifying which feature codes mobile device are allowed to access. The mobile switching center stores such information in memory, e.g., in the form of a table containing grouping information for all currently registered mobile devices. When a mobile switching center receives a feature request from a mobile device in which the mobile device requests a feature that they are not authorized for, the mobile switching center denies the request, and does not exchange FEATREQ messages with the home location register. This technique frees up computing resources at the mobile switching center and the home location register and reduces the amount of IS-41 MAP signaling messages exchanged between the two entities.

### BACKGROUND

1 Field

This invention relates generally to the field of wireless communications and more particularly to a method of more efficiently handing feature requests for mobile terminals in a mobile switching center.

2 Description of Related Art

The international standards document TIA/EIA/IS-41-D sets forth a network architecture for providing mobile telecommunications and networking. Commercial deployments of mobile telecommunications networks in compliance with IS-41 have occurred in North America and elsewhere. Such systems include a wireless communication network infrastructure (e.g., Code Division Multiple Access (CDMA) cellular telephone network) which includes a multitude of base transceiver stations and associated antennae for communicating over an air interface with roaming mobile terminals, base station controllers, and mobile switching centers (MSC) which perform switching operations to direct calls to a mobile terminal via a base station controller and a base transceiver station.

Users of mobile terminals typically enter a service agreement with a provider of wireless services, such Verizon, T-Mobile or Cingular. Such service agreement typically sets forth a package of features and services the subscriber is allowed to use. If they wish to invoke a particular service, such as call forwarding, they press a key such as the * key on their terminal and a feature code in the form of a dialing string, such as *72 for call forwarding. Thus, to implement call forwarding to telephone number 604-273-1234, the user might press *726042731234. This dialing string is then sent through the base station subsystem infrastructure to an MSC currently serving the terminal. Sometimes, a subscriber seeks to invoke a service that is not part of their service plan. There needs to be a mechanism in place for determining whether mobile terminals are allowed to use features that they have signed up and paid for.

It so happens that IS-41 includes a messaging mechanism whereby a home location register (HLR, typically a computing node on the service provider backbone network) provides information to a MSC which indicates whether a particular mobile terminal is permitted to invoke a feature or service which is offered by the subscriber's wireless service provider. Such features can include features like Do Not Disturb, Call Blocking, Call Forwarding (as explained in the above example), Flexible Alerting, and others. Flexible Alerting allows users to be contacted simultaneously at multiple phone numbers, including home and office phones, mobile phones, and pagers. Callers reach the users by dialing a single pilot directory number. The call is completed on the first phone that answers.

In all known deployments, this feature code control is normally done in the HLR. In particular, every time a MSC receives a request from a mobile terminal to use a feature (such as where the mobile terminal enters a feature code into their terminal), the MSC queries the HLR with a FEATREQ (FeatureRequest) message and then receives a FEATREQ response message from the HLR indicating whether or not the feature is allowed. Moreover, the HLR controls the availability of the wireless features for each mobile subscriber individually. It does not embrace a concept of grouping mobile subscribers into groups can perform certain wireless features. Thus, each time a mobile subscriber attempts to activate a wireless feature using a feature code string (e.g., *72), an MSC has to send a FeatureRequest invoke message to the HLR and wait for a response message. Depending on the authorization status for this wireless feature, the HLR will return a successful or unsuccessful FeatureResult in a FeatureRequest return result message sent from the HLR to the MSC.

In a large wireless network with millions of subscribers, registration, deregistration, activation, and deactivation of various wireless features can create a lot of IS-41 Mobile Application Part (MAP) signaling traffic between the MSC and the HLR. Such signaling traffic ties up computing resources in both the MSC and the HLR and uses bandwidth on networks between the MSC and HLR. There is a need in the art for handing feature requests for mobile terminals in a more efficient manner. This invention meets that need.

### SUMMARY OF THE INVENTION

The following embodiments and aspects thereof are described and illustrated in conjunction with systems, tools and methods which are meant to be exemplary and illustrative, not limiting in scope.

In a first aspect, a method of controlling availability of features for a mobile communications device is provided. The features are typically features provided by a wireless service provider and can includes such features as Do Not Disturb, Call Forwarding, etc. Typically, such features are requested by activation of feature codes such as *72. The method includes a step of receiving a message at a mobile switching center identifying the mobile device as being a member of a group that is associated with one or more features for mobile devices. For example, a mobile device may be assigned as a member of Group A, where mobile devices in Group A are allowed to use Call Forwarding. The mobile switching center stores the grouping and features assigned to the mobile device in a memory, e.g., in the form of a table or database that relates mobile features to a particular group assigned to the mobile device. When the mobile device sends a feature request code, such code is forwarded to the mobile switching center and processed in the mobile switching center. The mobile switching center processes the feature request by reference to the table. In the event that the mobile device requests utilization of a feature that it is not allowed to access (based on the grouping assigned to the mobile device), the request is denied by the mobile switching center, e.g., by sending a feature request denied message back to the mobile device. In particular, since the mobile switching center knows that the mobile is not allowed to access the feature (because the grouping for the mobile device in the table says so), it need not and does not exchange feature request messages with a home location register. As such, the MAP signaling traffic between the mobile switching center and the home location register can be reduced significantly—no MAP signaling traffic is used where the mobile device makes a request for a feature which is invalid. Furthermore, computing resources at the mobile switching center and the home location register are preserved for other activity.

In one embodiment, a mobile device is grouped into just one group, and the group is defined by the features (may be one or more) that all mobile devices with this grouping are allowed to use. For example, if a mobile device is grouped into group X, all mobile devices with grouping X are allowed to access both Call Forwarding and Do Not Disturb, but not Flexible Alerting. As another example, if a mobile device is grouped into group Y, then all such mobile devices belonging to Group Y are allowed Flexible Alerting but no other services. In other words, there is a one to one relationship between mobile devices and groups. The particular manner in which the groupings are set up and maintained in the mobile switching center is not particularly important and can vary from the specifics disclosed herein.

In one preferred embodiment, the mobile switching center receives the message that identifies a mobile device as being in a particular group from a home location register. Such message may be sent as a response to a registration notification message (e.g., REGNOT in IS-41). The identification of grouping(s) the mobile device is assigned to can be set forth in an OriginationIndicator parameter of the message. More particularly, the OriginationIndicator parameter includes a length field comprising octet of data including extension values between 224 and 255, inclusive. The mobile device is assigned one value of between 224 and 255, and each value assigned is associated with one or more particular features a mobile device is allowed to access. Thus, for example, a mobile device that is assigned a value of 224 is allowed to access one set of features, whereas a mobile device assigned a value of 225 is allowed to access a different set of features.

In a preferred embodiment, in the event that a mobile device seeks to use a feature which is permitted based on the grouping assigned to the mobile device, the method further comprises the step of sending a feature request message (FEATREQ in IS-41) from the mobile switching center to the home location register. Such feature request message can be sent for a variety of reasons: (a) to make sure that the home location register operator has not recently changed the grouping assigned to the mobile device, e.g., in response to the mobile device changing their service plan, (b) to restrict access to features in the event that the mobile device is reported stolen, and (c) possibly for cost accounting reasons, e.g., where the wireless service provider bills the customer based on the number of times a particular feature is used and obtains usage data from a home location register either directly or indirectly.

In another aspect, a mobile switching center is described which provides feature control for mobile devices. The mobile switching center includes a memory storing a table assigning mobile devices to plurality of particular groups, wherein each mobile device is assigned to one group, each group associated with at least one feature provided by a wireless service provider. The mobile switching center further includes a processing unit responsive to feature requests from the mobile devices by reference to the table, wherein in the event that the mobile device requests a feature that is not allowed for the mobile device based on the assignment of one group to the mobile device, the request is denied without exchange of feature request messages between the mobile switching center and a home location register.

In still another aspect, a home location register for a plurality of mobile devices is described. The home location register includes a memory storing data associating mobile devices with particular groups. In one embodiment, each mobile device is associated with a particular group (e.g. 224) wherein all mobile devices in the particular group having the same availability of features. The home location register further includes a processing unit responding to a registration notification message from a mobile switching center by sending a response message indicating which feature group a particular mobile device belongs to. The mobile switching center can then use the grouping information to populate a table and use such table to process feature request messages, as explained above.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is an illustration of a network including a mobile switching center and home location register which cooperate to provide improved feature control for mobile devices.

FIG. 2 is a block diagram of a mobile switching center and a home location register exchanging registration notification messages when a mobile device of FIG. 1 first registers with the mobile switching center. In one embodiment, the response message from the home location register includes an OriginationIndicator parameter which provides the feature grouping for a mobile device to the mobile switching center.

FIG. 3 is an illustration of a correlation of OriginationIndicator extension values to particular features which mobile devices are allowed to use.

FIG. 4 is an illustration of a feature control table stored in a memory associated with the mobile switching center, in which each mobile device is assigned one of the extension values and thereby is grouped in a group associated with particular features.

FIG. 5 is an illustration of an exchange of feature request messages which may be exchanged between the mobile switching center and the home location register in the event that the mobile device requests access to a feature that they are allowed as indicated in the table of FIG. 4.

FIG. 6 is a flow chart showing processing instructions executing on a mobile switching center which provides for intelligent feature control using the table of FIG. 4 and the messages of FIGS. 2 and 5.

### DETAILED DESCRIPTION

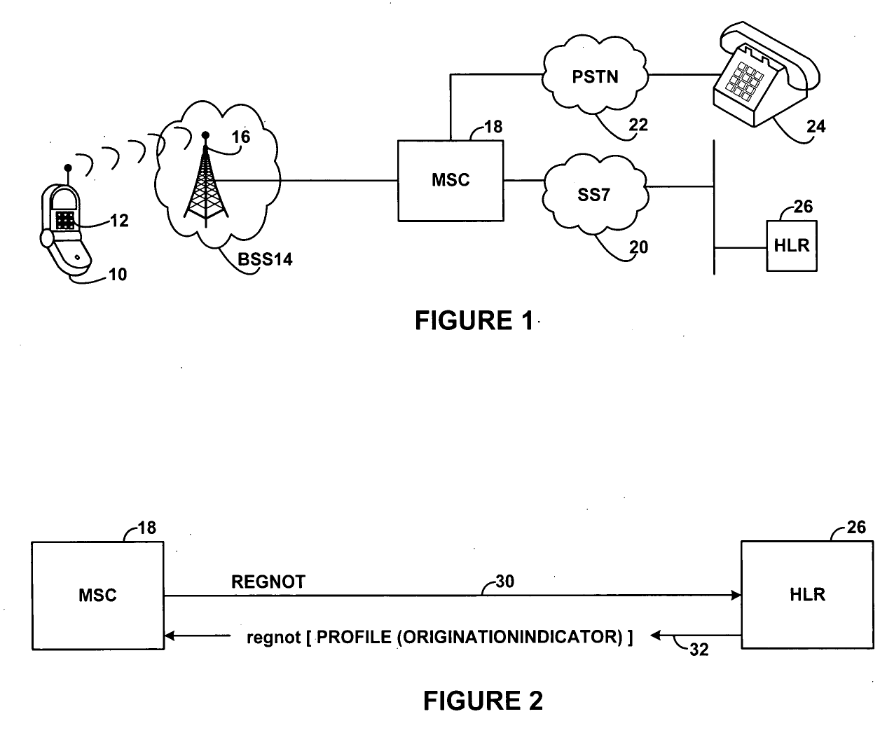

Referring now to FIG. 1, a mobile device 10 such as a cellular telephone, personal digital assistant, or laptop computer, includes a keypad 12 by which a user can enter feature codes in the form of a dialing string in order to invoke features provided by their wireless service provider. The feature codes are sent over an air interface to a base station subsystem 14 which includes a base transceiver station antenna 16. The base station subsystem 14 is connected to a mobile switching center (MSC) 18. The MSC 18 is coupled (either directly or indirectly) to a signaling system 7 (SS7) network 20, which may for example be a wireless service provider backbone network. The network 20 includes a home location register 26, which may take the form of a computing resource such as network server having a data processor and a memory. Similarly, the MSC may include a data processor processing feature requests from mobile devices and includes a memory storing program instructions. The general functionality of the MSC and HLR entities are set forth in the pertinent standards documents (e.g., IS-41-D), and are known in the art, therefore a detailed discussion is omitted.

The mobile device may be engaged in a telephone call with a telephone 24 via the public switched telephone network 22 in known fashion using known protocols.

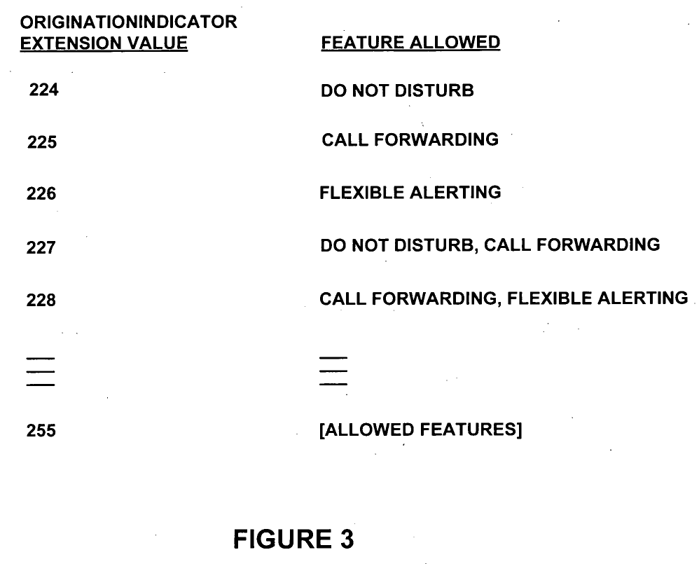

When the mobile device 10 first registers with the base station subsystem 14, such as when the user of the mobile device turns the device on, a registration process happens. In particular, the base station subsystem 14 sends a control message to the MSC 18 and the MSC responsively sends a REGNOT message 30 (defined by IS-41) to the HLR 26 as shown in FIG. 2. The HLR 26 responds with a REGNOT response message 32 which includes a profile for the mobile device 10 (such as what types of calls the mobile device is allowed to make). The REGNOT response message includes an Originationindicator field which defines the types of calls the mobile device can make. Furthermore, the OriginationIndicator field includes an octet of data that includes extension values 224-255 which are used in this invention to identify a grouping of features (i.e., features requested by the use of feature codes) that the mobile device is allowed to use. FIG. 3 shows one example of how extension values can be associated with particular features. In the example of FIG. 3, if the extension value of 224 is assigned to the mobile device and is included in the message 32 of FIG. 2, the mobile device is allowed to use a Do Not Disturb feature. As another example, if the extension value of 228 is included, the mobile device can use a call forwarding feature and a flexible alerting feature. Thus, the features defined by the extension values could be one-to-one (i.e., each extension value is associated to one feature), or one to many (each extension value could be associated to more than one feature). The mobile device thus are preferably assigned to one group (e.g., mobile device is assigned to group 224), with each group associated with one or more features.

While the illustrated embodiment uses the REGNOT response message as the message in which grouping of mobile devices to features is provided to the MSC, it is possible to use other messages defined by IS-41 or other message not defined by IS-41 to convey this information to the MSC. The scope of this invention is broad enough to encompass other messaging formats.

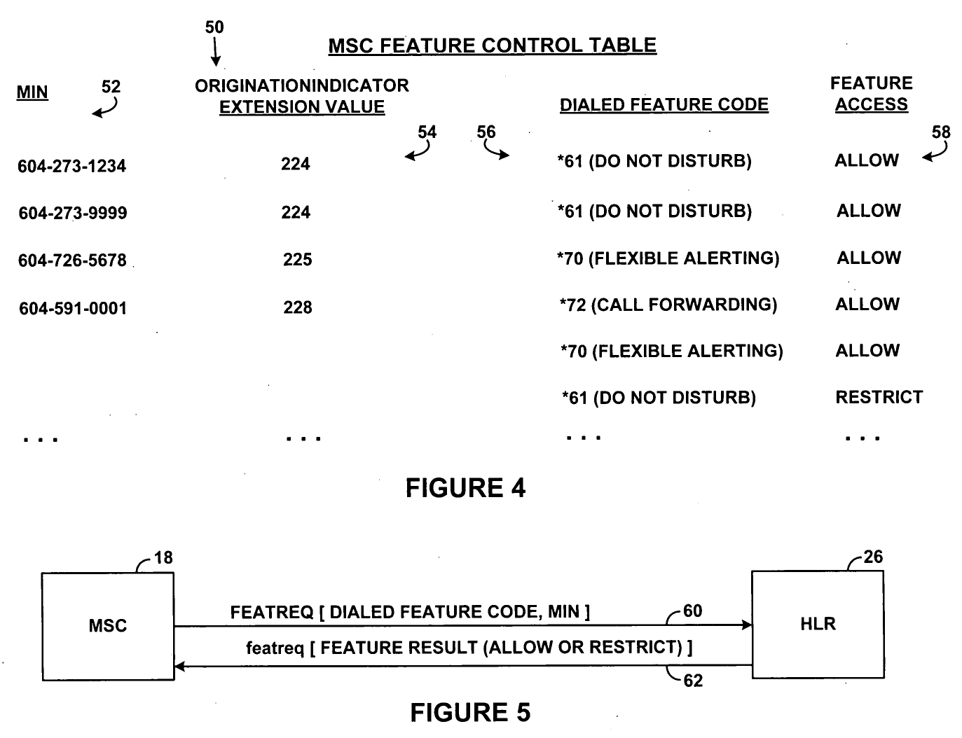

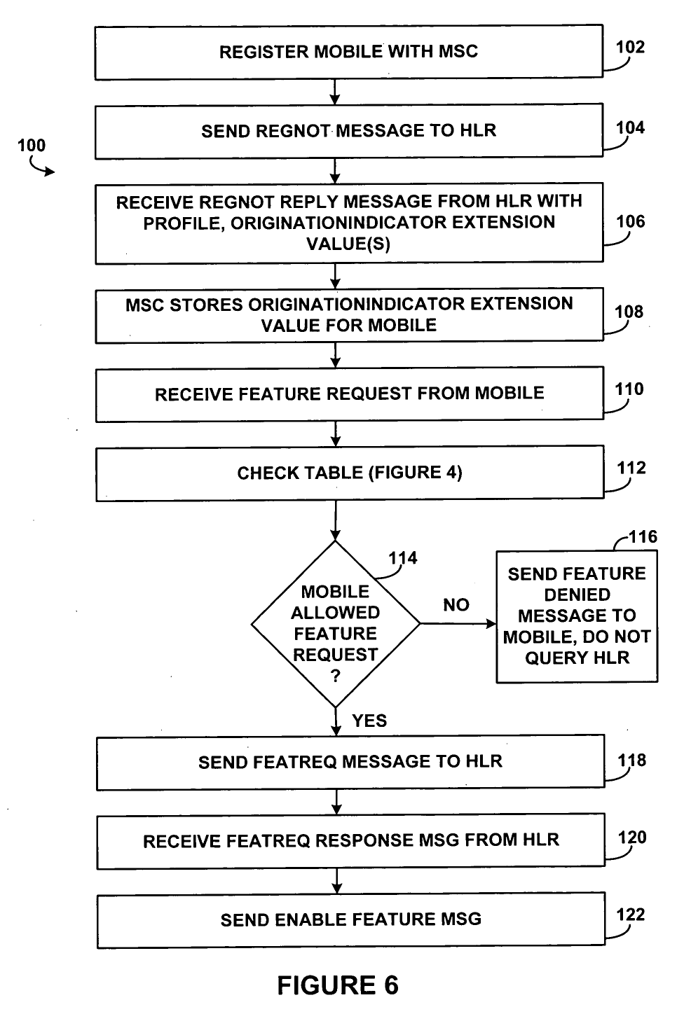

It will be appreciated that each time a mobile device 10 registers with the MSC, the exchange of message as shown in FIG. 2 occurs. Thus, the MSC 18 is continually acquiring extension values that group or assign mobile devices to particular features. The MSC 18 preferably stores such information in the form of a table in memory. One example of such a table 50 is shown in FIG. 4. The left hand column 52 includes the mobile identification number (MIN) for each mobile device that is currently registered with the MSC. The next column 54 identifies the OriginationIndicator extension value that was provided to the MSC by the HLR. For example, MIN 604-273-1234 was identified by the HLR as having an extension value of 224 in the REGNOT response message 32 of FIG. 2 and such information is stored in the table 50. The next column 56 indicates which feature code is associated with the extension field 224. The right hand column 58 indicates whether to allow or restrict access to this feature. For example, the table indicates that mobile devices assigned to group 224 allow Do Not Disturb feature code *61. Mobile devices assigned to group 225 are allowed to use the *70 feature code for Flexible Alerting. Mobile devices such as the one with MIN 604-591-0001 which are assigned group 228 are allowed to use the call forwarding and flexible alerting features, but are not allowed to use the Do Not Disturb feature. Thus, in one possible implementation the groups could be defined such that they define allowed features, or allow some features but restrict other features. Furthermore, as explained above, more than one feature could be assigned to a single group, as in the case with extension value 228 in FIG. 4. The particular manner in which the table 50 is constructed is not particularly important and it could take other forms, such as a listing of all MINs belonging to group 224, all MINs belonging to group 225, etc., along with an identification of the allowed features associated with groups 224, 225, etc.

Thus, the MSC 18 maintains a table such as the one shown in FIG. 4 for all home and roaming mobile devices which may be served by the MSC. The contents of the table 50 are populated at the time the MSC is configured. Suppose at some later time the MSC 18 receives a request from a mobile device to use some feature such as Do Not Disturb. When mobile 604-273-1234 tries to activate the “Do Not Disturb” wireless feature, the MSC 18 consults the table 50 by checking the MIN, OriginationIndicator extension value (Column 54), and dialed feature code (column 56) and determines that it is allowed to access this feature (column 58).

The MSC 18 then sends a FEATREQ to the HLR 26, as shown in FIG. 5. The HLR 26 confirms that the mobile device is allowed to use the feature (e.g., no recent changes in the mobile's service plan have occurs, the mobile is not reported as stolen, etc.) and sends back a FEATREQ response message which includes a Boolean field FEATURERESULT which indicates whether the feature is allowed. The MSC 18 then sends a signal to the base station subsystem 14 for transmission to the mobile device indicating that the feature is allowed.

Note that the MSC 18 will also allow mobile 604-273-9999 to also access Do Not Disturb because it belongs to the same group—those mobiles with an OriginationIndicator value of 224.

However, the MSC will deny mobile device with MIN 604-726-5678 access to the Do Not Disturb feature because it belongs to a different group (those mobile devices with an OriginationIndicator value 225), and mobiles in group 225 are only allowed to access Flexible Alerting.

In the event that the MSC 18 receives a request by MIN 604-726-5678 to access the Do Not Disturb feature, rather than exchanging FEATREQ messages with the HLR, as shown in FIG. 5, the MSC 18 can immediately deny the request and send a feature request denied message to the base station subsystem 14 for transmission to the mobile device. An exchange of FEATREQ messages between the MSC and the HLR is not needed and is not performed. This saves computing power at the MSC and the HLR and avoids the use of MAP signaling traffic containing FEATREQ messages between the MSC and the HLR, where the MSC already knows that the mobile device is not allowed to use a feature by virtue of the table 50.

Still referring to FIG. 4, consider the further situation where mobile device with MIN 604-591-0001 is registered with the MSC. The OriginationIndicator extension value (228) in the regnot reply message 32 of FIG. 2 is stored in memory in the MSC with the MIN of this mobile, in the table 50. When the mobile device with MIN 604-591-0001 tries to activate the “Do Not Disturb” wireless feature, the MSC checks table 50 and its MIN, OriginationIndicator, and dialed feature code, and determines that it is not allowed to access this feature. The MSC does not send a FEATREQ to the HLR and it sends a denied message back to the mobile. Conversely, if the mobile with MIN 604-591-0001 seeks to access Flexible Alerting, then the MSC determines by virtue of the table 50 that this mobile device is allowed to use this feature and then exchanges the FEATREQ messages with the HLR as shown in FIG. 5.

In one further aspect, the invention can be embodied in a MSC 18 that includes a memory storing a table (e.g., one such as shown in FIG. 4) which assigns mobile devices to a particular group, wherein each mobile device is assigned to a particular group (e.g., 224, 225, etc.) and all the mobile devices in the particular group are allowed the same access to features provided by a wireless service provider. The mobile switching center further includes a processing unit responsive to feature requests from the mobile devices by reference to the table 50, wherein in the event that the mobile device requests a feature that is not allowed for mobile devices in the group the mobile device is assigned to, the request is denied without exchange of feature request messages between the mobile switching center 18 and the home location register 26.

The MSC 18 implements a processing routine for responding to mobile device registration and feature requests. One embodiment of the processing routine 100 is shown in flow chart form in FIG. 6. At step 102, the MSC receives a request message to register a mobile device with the MSC. At step 104, the MSC sends a REGNOT message to the HLR (FIG. 2). At step 106, the MSC receives a REGNOT reply message from the HLR which includes a profile for the mobile and Originationindicator extension value which identifies which group of features the mobile device is allowed to access, as explained above. At step 108, the MSC stores the information received at step 106 in memory to be used with the table 50 of FIG. 4.

At step 110, the MSC receives a feature request message from the mobile. At step 112, the MSC checks the table 50 of FIG. 4. At step 114, the MSC determines whether the mobile is allowed to access the feature, by consulting the fields 52, 54, 56 and 58 of the table 50. If the mobile is not allowed to access the feature, the MSC sends a feature denied message to the mobile and does not send a FEATREQ message to the HLR. On the other hand, if at step 114 the mobile is allowed to access the feature, the MSC sends a FEATREQ message to the HLR at step 118. The HLR checks is memory to confirm that the mobile is allowed to the use the feature identified in the FEATREQ message. At step 120, the HLR sends a FEATREQ response message back to the MSC which is received at the MSC. At step 122 (assuming the mobile is still allowed to use the feature), the MSC sends a feature enabled message 122 back to the base station subsystem 14 for delivery to the mobile device.

In still another aspect, the invention can be embodied in a home location register 26. The home location register includes a memory (not shown, but conventional) storing data associating mobile devices with particular groups. Such information can be provided to the home location register by a server in the service provider network that includes profile data for mobile subscribers, or in any other convenient format, the details of which are not important. In one embodiment, each mobile device is associated with a particular group (e.g. 224) wherein all mobile devices in the particular group having the same availability of features. The home location register further includes a processing unit (not shown, but conventional) responding to a registration notification message 30 (FIG. 2) from a mobile switching center 18 by sending a response message 32 indicating which group a particular mobile device belongs to. The mobile switching center can then use the grouping information provided from the HLR 26 to populate a table (FIG. 4) and use such table to process feature request messages, as explained above.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A method of controlling availability of features for a mobile communications device, wherein the mobile device is assigned to a group, wherein all mobile devices in the group have the same availability of features, the method comprising the steps of:
receiving a message at a mobile switching center identifying the mobile device as being a member of a particular group;
storing the grouping assigned to the mobile device in a memory associated with the mobile switching center; and
processing, in the mobile switching center, a feature request from the mobile device at the mobile switching center by reference to the table,
wherein in the event that the mobile device requests utilization of a feature that is not allowed for mobile devices in the group the mobile device is assigned to, the request is denied without exchange of feature request messages between the mobile switching center and a home location register.

2. The method of claim 1, wherein the message identifying the mobile device as being in a particular group comprises a response to a registration notification message and wherein the grouping is indicated in an OriginationIndicator parameter of the message.

3. The method of claim 2, wherein the Originationindicator parameter includes an length field comprising octet of data including values between 224 and 255, inclusive, and wherein the mobile device is assigned to one value between 224 and 255, and wherein the value assigned is associated with a group of one or more particular features a mobile device is allowed to access.

4. The method of claim 1, wherein in the event that the mobile device seeks to use a feature which is permitted for mobile devices in the group, the method further comprises the step of sending a feature request message from the mobile switching center to the home location register.

5. The method of claim 1, wherein the feature comprise a feature requested by the mobile device by activation of a feature code on the mobile device.

6. A mobile switching center providing feature control for mobile devices comprising:
a memory storing a table assigning mobile devices to plurality of particular groups, wherein each mobile device is assigned to a particular group and all the mobile devices in the particular group are allowed the same access to features provided by a wireless service provider; and
a processing unit responsive to feature requests from the mobile devices by reference to the table, wherein in the event that the mobile device requests a feature that is not allowed for mobile devices in the group the mobile device is assigned to, the request is denied without exchange of feature request messages between the mobile switching center and a home location register.

7. The mobile switching center of claim 6, wherein the memory is augmented to assign a particular mobile device to a particular group in response to a registration notification message received from the home location register, and wherein the grouping for the mobile device is indicated in an Originationindicator parameter of the message.

8. The mobile switching center of claim 7, wherein the OriginationIndicator parameter includes an length field comprising octet of data including values between 224 and 255, inclusive, and wherein the mobile device is assigned to one value between 224 and 255, and wherein the value assigned is associated with a group of one or more particular features a mobile device is allowed to access.

9. The mobile switching center of claim 6, wherein in the event that the mobile device seeks to use a feature which is permitted for mobile devices in the group, the mobile switching center sends a feature request message to the home location register.

10. The mobile switching center of claim 6, wherein the feature comprise a feature requested by the mobile device by activation of a feature code on the mobile device.

11. A home location register for a plurality of mobile devices, comprising:
a memory storing data associating mobile devices with particular groups, each mobile device associated with a particular group wherein all mobile devices in the particular group having the same availability of features; and
a processing unit responding to a registration notification message from a mobile switching center by sending a response message indicating which group a particular mobile device belongs to.

12. The home location register of claim 11, wherein the response message includes an OriginationIndicator parameter and wherein the indication of the grouping is included in the OriginationIndicator parameter of the response message.

13. The home location register of claim 12, wherein the Originationindicator parameter includes an length field comprising octet of data including values between 224 and 255, inclusive, and wherein the mobile device is assigned to one value between 224 and 255, and wherein the value assigned is associated with a group of one or more particular features a mobile device is allowed to access.

14. The home location register of claim 11, wherein the features comprise a feature requested by the mobile device by activation of a feature code on the mobile device.
